(19) United States
(12) Patent Application Publication
(10) Pub. No.: US 2016/0104387 A1
(43) Pub. Date: Apr. 14, 2016

(54) INTERACTIVE ONLINE LEARNING SYSTEM AND METHOD

(71) Applicant: Proll IT Services Inc., Vancouver (CA)

(72) Inventors: Karen Bakker, Vancouver (CA); Kyle Robertson, Vancouver (CA)

(21) Appl. No.: 14/855,211

(22) Filed: Sep. 15, 2015

Related U.S. Application Data
(60) Provisional application No. 62/050,700, filed on Sep. 15, 2014.

(51) Int. Cl. G09B 5/08; G09B 5/02

(52) U.S. Cl. CPC G09B 5/08; G09B 5/02

(57) ABSTRACT

An interactive online learning system and method.

### BRIEF DESCRIPTION OF THE FIGURES

FIG. 1 depicts a title page.

FIG. 2 depicts a vision statement.

FIG. 3 depicts co-founders.

FIG. 4 depicts a growing market.

FIG. 5 depicts a problem description.

FIG. 6. depicts a solution description.

FIG. 7. depicts a business model.

FIG. 8. depicts spectra of personalization and interaction.

FIG. 9. depicts a user pipeline.

FIG. 10. depicts a forecast.

FIG. 11. depicts business metrics.

FIG. 12. depicts design attributes.

FIG. 13. depicts a development stage.

FIG. 14. depicts a conclusion page.

### DETAILED DESCRIPTION:

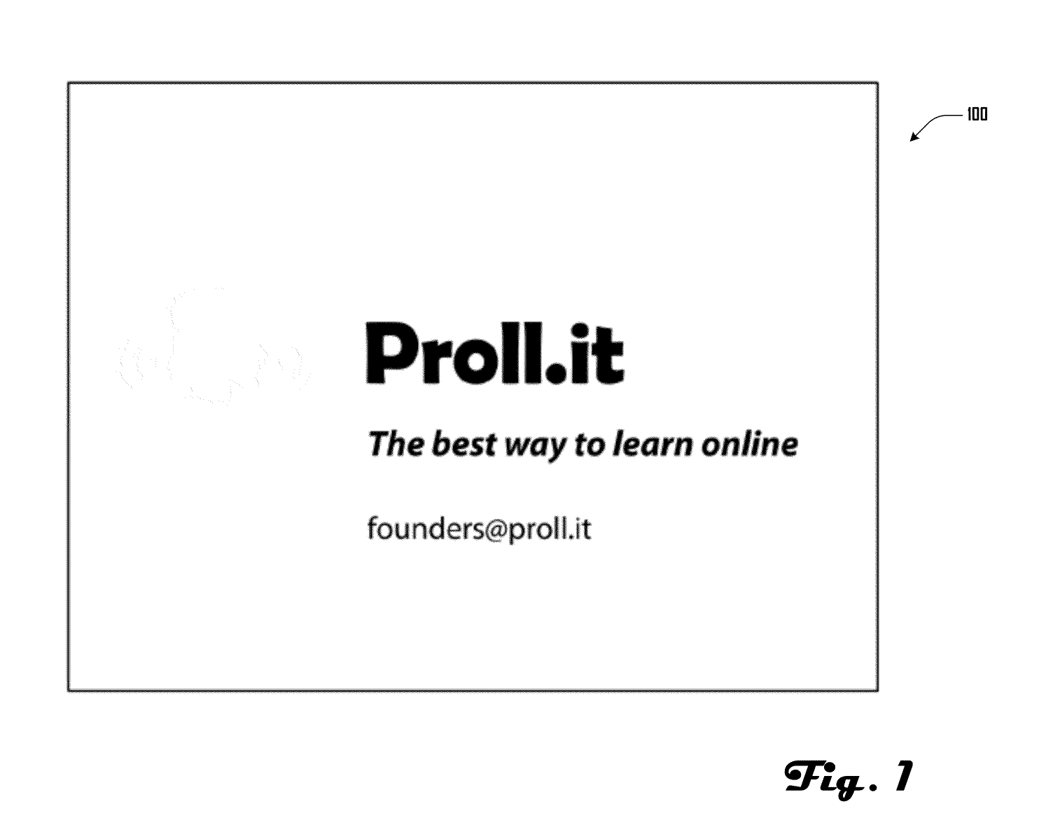

FIG. 1 depicts a title page.

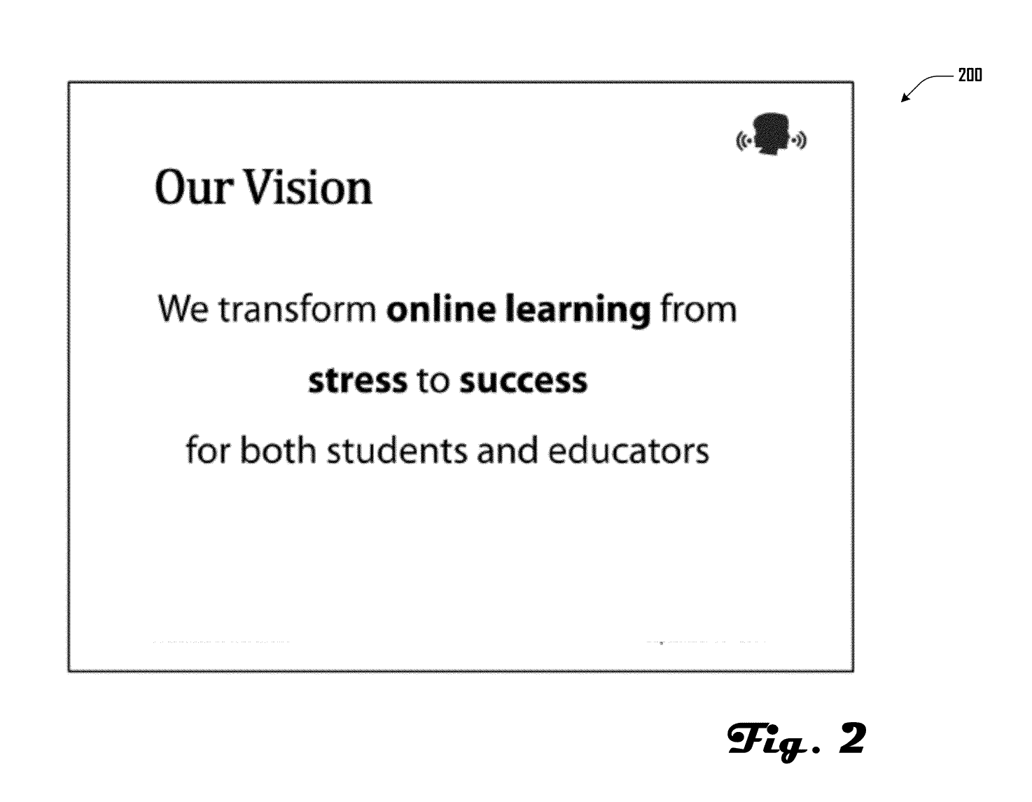

FIG. 2 depicts a vision statement.

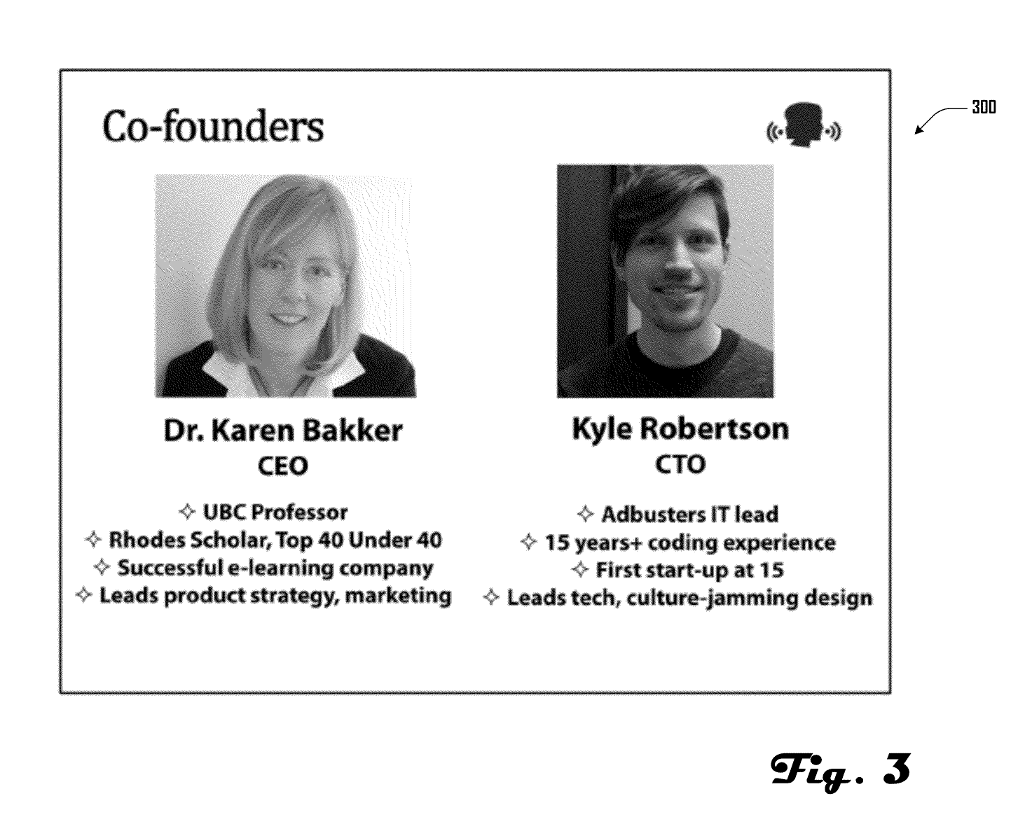

FIG. 3 depicts co-founders.

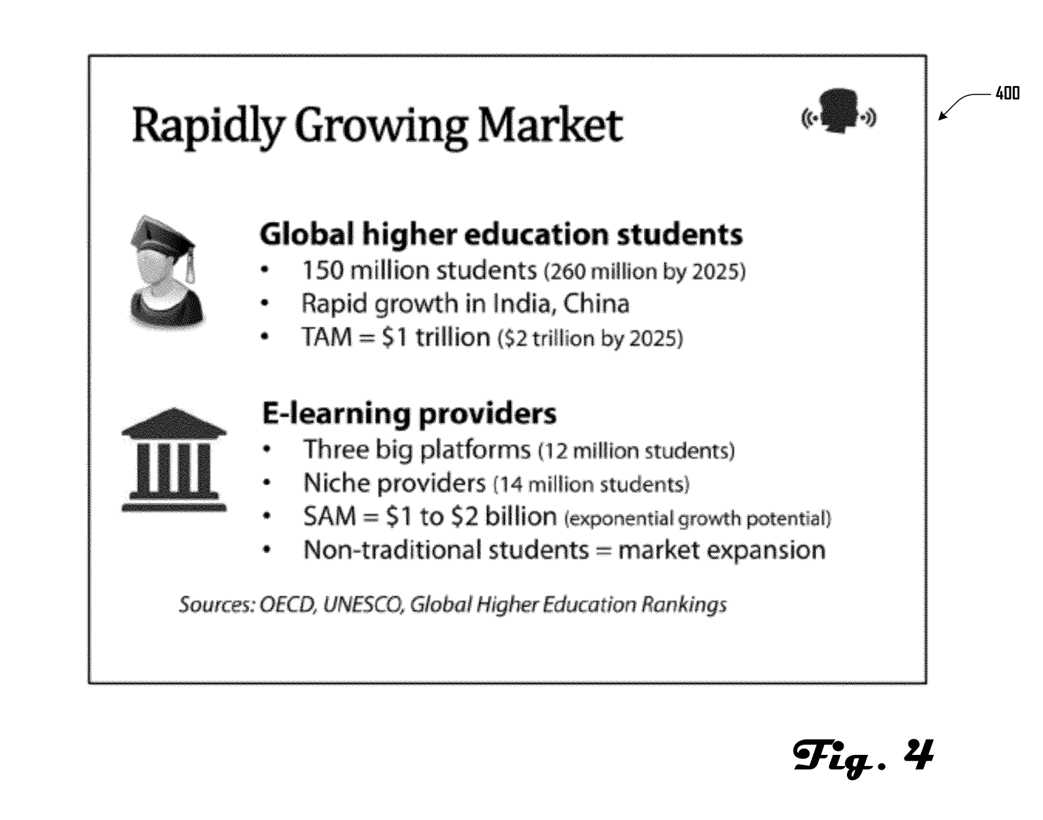

FIG. 4 depicts a growing market.

Likelihood of hybrid degrees (a portion online) for all universities in the future; as well as growth of entirely online universities.

Question: How to tap rapidly growing higher education market?

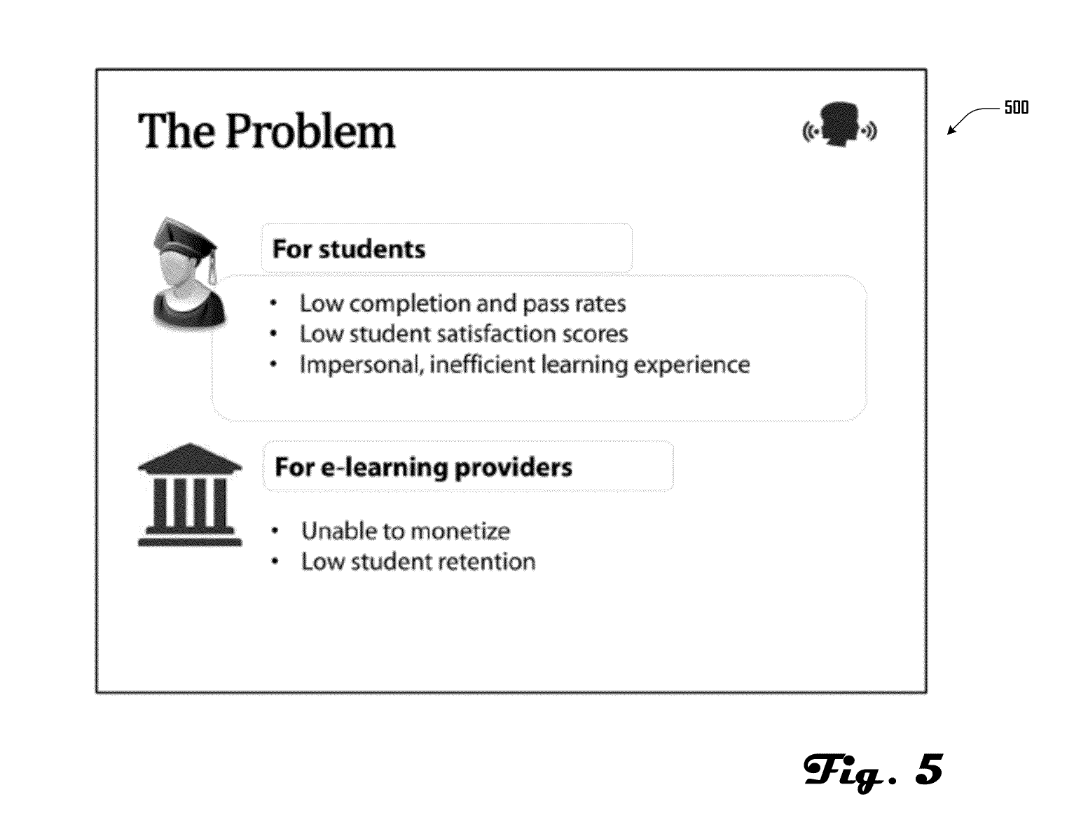

FIG. 5 depicts a problem description.

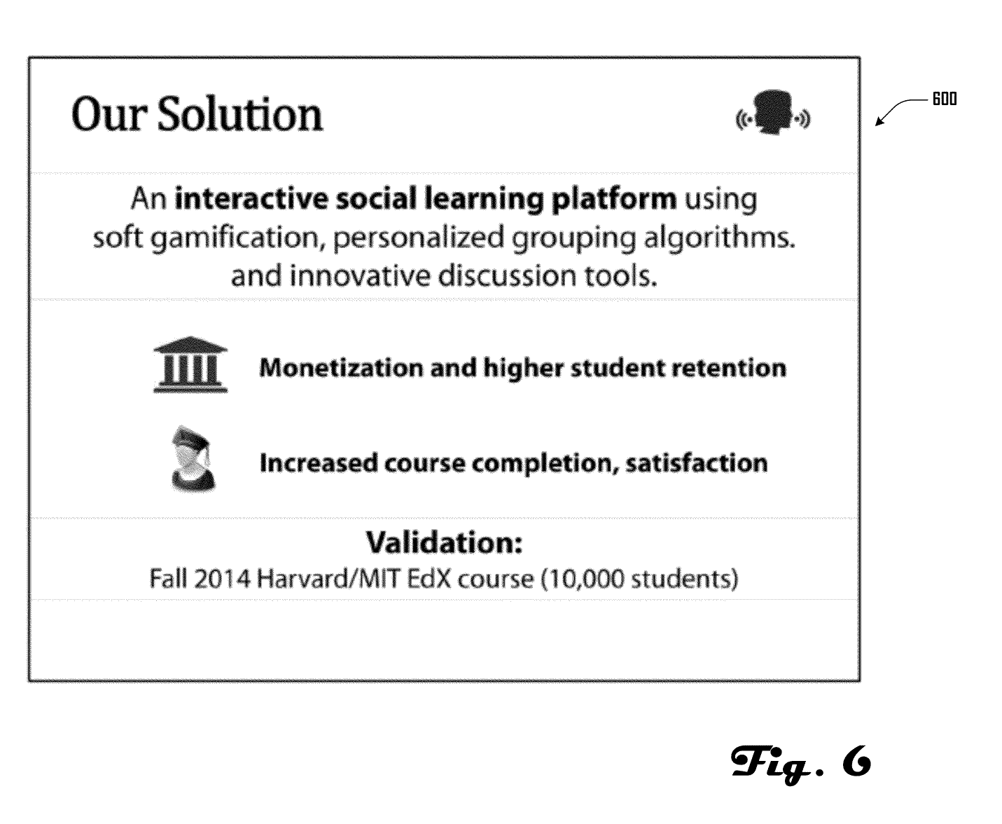

FIG. 6. depicts a solution description.

E-learning providers=customers

Students=users

We are NOT a content provider. We think the marginal cost of content is going to go very low, very quickly.

We think that the monetization potential is in other areas. Online learners have been targeting proctoring and accreditation, but we're targeting discussion and engagement.

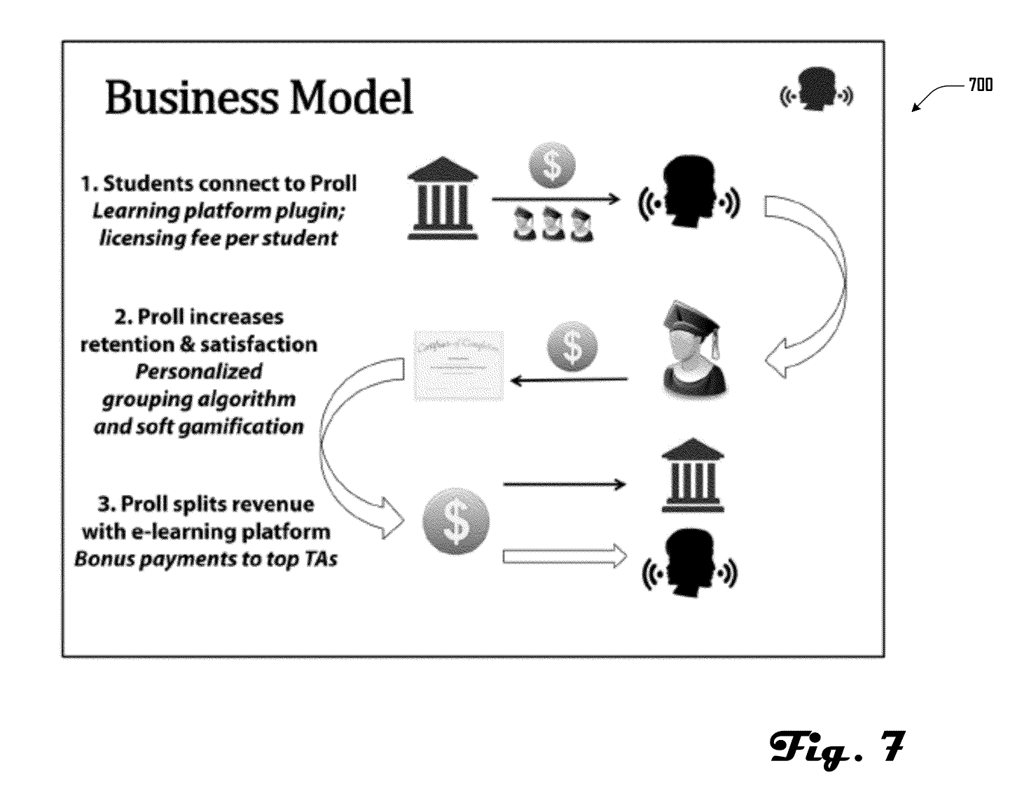

FIG. 7. depicts a business model.

Converts discussion forums from a low-touch to a high-touch environment, which is peer-driven.

Distinct Features:

(i) Designed for non-STEM as well as STEM students.

(ii) Quantifies discussion participation in a proprietary Proll Score algorithm—enabling discussion marks to be included in final MOOC mark

(iii) Score EQ as well as IQ. Question: who would you rather hire—a student who got 96% in a course, but was ranked as very unhelpful by fellow students, with low engagement and contribution score; or a student who got 91% in the same course, but was ranked amongst the top 10 most helpful and active contributors? This will be particularly of interest to employers as face-to-face contact reduces in an online education world (how are you going to write a reference letter for a student you have never met?).

Unique Niche:

(ii) Patented features for soft gamification, interactivity, engagement. These capture EQ (rather than IQ), and are represented in a Proll Score algorithm, which is (a) a portion of the final course mark (something currently not possible with the current online learning technology) first to do this, and (b) is also noted on a separate Participation Certificate the students receive for the course. In the online job training space, this will give additional information to prospective employers about students with high EQ and IQ.

Proll measures attributes employers want: ability to work in teams, EQ, etc . . . .

Note: In the MOOC space, we anticipate that students will be willing to pay for these Participation Certificates—just like they currently pay for the Course Completion Certificate from the MOOC providers.

TAs: are also incentivized because students can rank them—top TAs are recognized with a certificate—rather than an unthanked volunteer job it is a credible contribution you can put on a CV—important for the graduate students and sessionals who are currently doing a lot of this work for free. And a great gatekeeping strategy for the use of virtual community Tas, which is what is currently being tested in some online learning environments.

Incentives
E.g. Students: Top Prollsters, Proll Score, Certificate
TAs: Tips & Certificate
MOOC platform: revenue, increased engagement, course completion

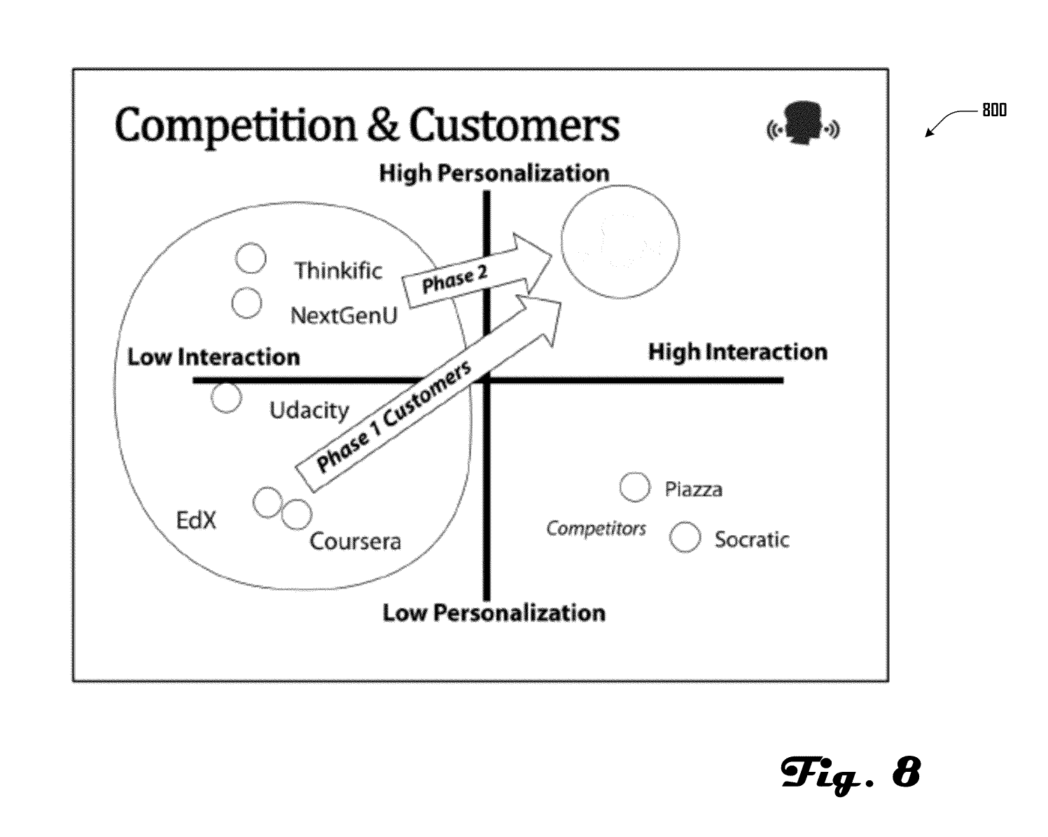

FIG. 8. depicts spectra of personalization and interaction.

A new opportunity in an emerging market that has not yet figured out how to monetize.

We are piggybacking on platforms that many describe as disruptive.

BUT note that there is also a bigger market of traditional education (continuing ed., exec. Ed and professional recertification) moving online).

Key message: MOOCS are not our only opportunity, and the sector does not need to be successfully or massively disrupted for our model to work.

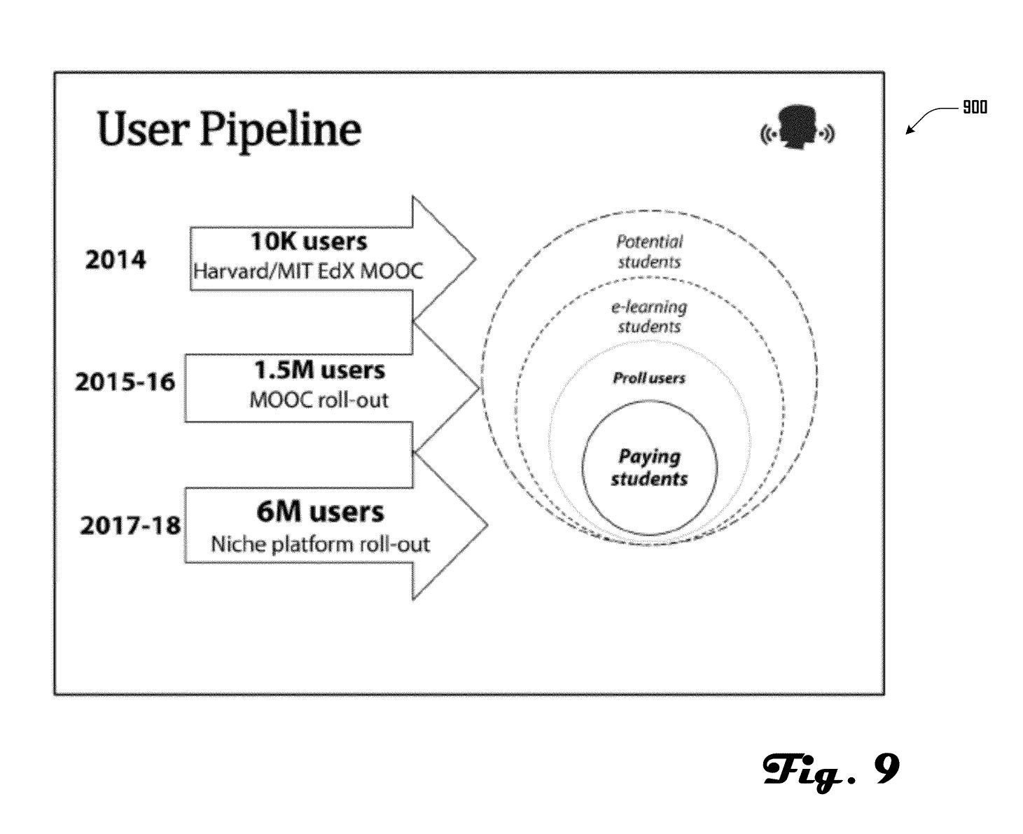

FIG. 9. depicts a user pipeline.

Risks and Barriers to Entry
Oligopoly (corporate ego) □ large and growing number of smaller providers to whom we can market—lacking in-house capacity to build discussion groups (Thinkific, ChinaNext); approach mid-size providers first (e.g. Udacity). Current MOOC providers=gateway (we can do an end-run focusing on niche providers, individual professors—but it will be more timeconsuming and slower to scale).
Suboptimal equilibrium—why would profs or student want more engagement?
Gamification and student WTP as yet unvalidated

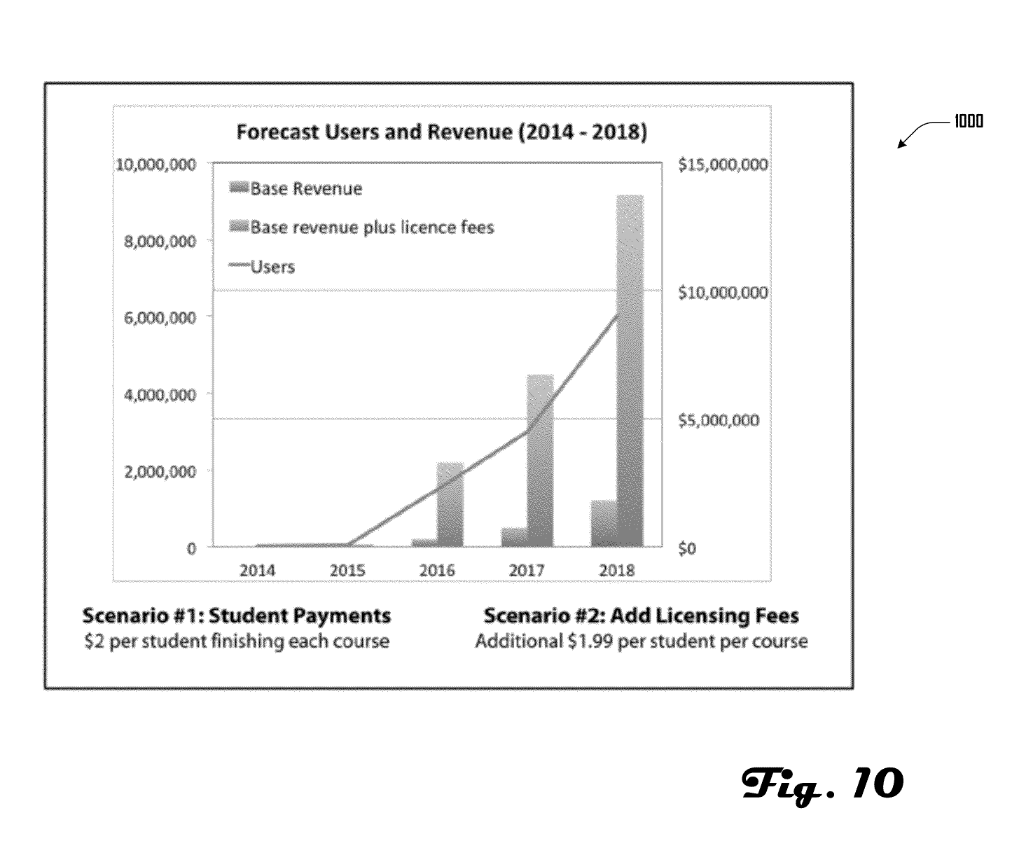

FIG. 10. depicts a forecast.

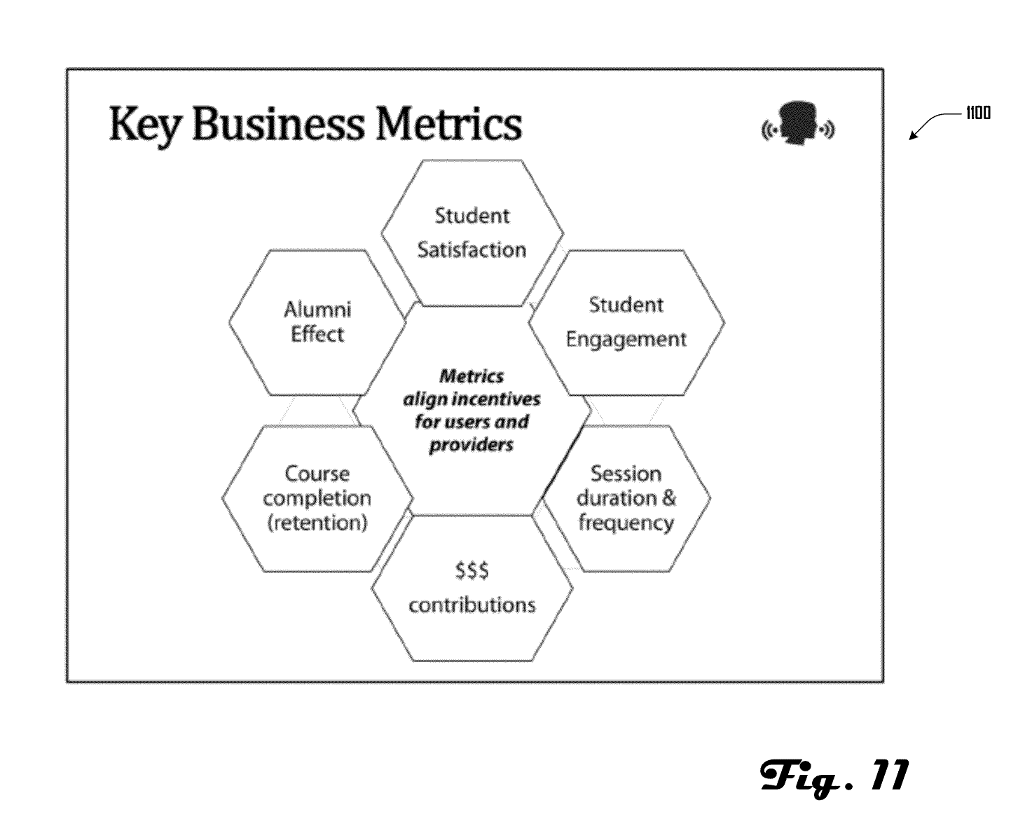

FIG. 11. depicts business metrics.

Our business model aligns our incentives with those of our users and customers, as measured by these key metrics.

Student engagement: (visits, number of contributions, length of response, ratings, peer review).

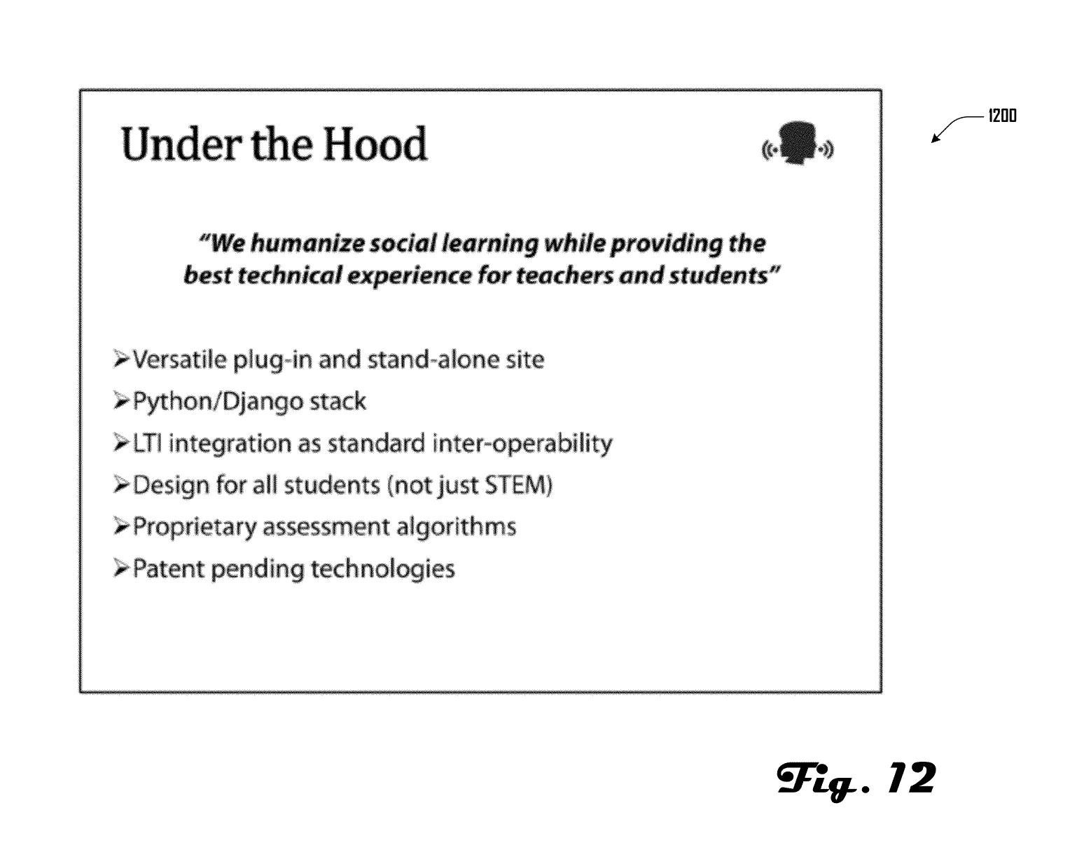

FIG. 12. depicts design attributes.

Design principles: Intuitive, easy to use, inviting

Design ethos: “friendly faces” in an “online campus” experience

Visual design leitmotifs: spiral and ampitheatre, using a “crowded café” analogy

Technical mission statement: Stable, fast platform

Full spectrum of learning: Arts/social science as well as STEM

List of target provisional patents. Note, if not otherweise specified, user may refer to professor (or teacher), student, and/or teaching assistant (or aide):

Participation Scoring
calculating a quotient of participation in a discussion (forum)
calculating a participation score using an algorithm based on duration and frequency of visits, length of contributions, and peer scoring
visual and verbal representation of the score with quantitative and qualitative metrics and elements

Option: certificate

Ranking of Users Based on Participation Scoring
ranking users based on activity in a social learning network

Option: ranking students

Option: ranking teaching assistants or other teaching aides

Option: ranking both teaching assistants (or other teaching aides) and students
calculating an overall score based on crowd-funding activity and participation in a social network
providing these rankings to third party services via an automated API

Option:—submitting a participation grade to a learning management system (LMS)

option: based on activity in a social network
visual and verbal representation of teacher/professor score with quantitative and qualitative metrics and elements

Option: certificate
visual and verbal representation of student score with quantitative and qualitative metrics and elements

Option: certificate
visual and verbal representation of TA score with quantitative and qualitative metrics and elements

Option: certificate
visual and verbal representation of for super-posters score with quantitative and qualitative metrics and elements

Option: certificate

Participation Context Quality Assessment
assessing the quality of content of participatory contributions based on user activity

Option: based on peer assessment
identifying the most “valuable” users in a social network (super-posters)
Assessment algorithm based on peer assessment of EQ metrics (e.g. helpfulness)

Participation—Linked Payment Process
compensating/paying users in a social network based on the value they generate
aggregating a “score” representing the value of a user in a social network
process for purchasing grades in a LMS
calculating a score representing crowd-funding activity

option: in the education space

option: for purchasing participation score
algorithm for calculating proportional cost of participation fee based on metrics and variables that are teacher and peer assessed

Personalized Grouping Algorithm for Participation in a Discussion Forum
grouping users based on participation in a social network

option: based on geographic location

12

option: matching for the sake of offline meeting
calculating an “ideal diversity metric” for participation in a social network

e.g. what composition of groups (previous activity, location, language, etc.)

encourage greatest participation
algorithm for matching students to tutors

Crowdfunding and Crowdcreating Learning Materials
process for crowd-funding learning materials
process for calculating proportional participatory contributions to learning materials
process for revenue sharing to co-creators of crowd-created learning materials

Design
Proll certificate
arranging inactive users in a semi-circle (the “audience”)
arranging active users in a spiral
using lines of text to create a spiral representing a discussion in a social network
moving avatars of inactive users from one area of an interface to another when they become active

(more specifically, from the semi-circle to the spiral)
using a spiral/galaxy design to represent frequency of participation and density of a social network
interface sequence: 1) visual representation of activity in a social network →2) content in the network
visualizing search results in a social network as facets of a geographic pattern
organizing content in a social network based on helpfulness
visually representing participation in a social network using a thermometer-like design
awarding badges or achievements to users of an LMS

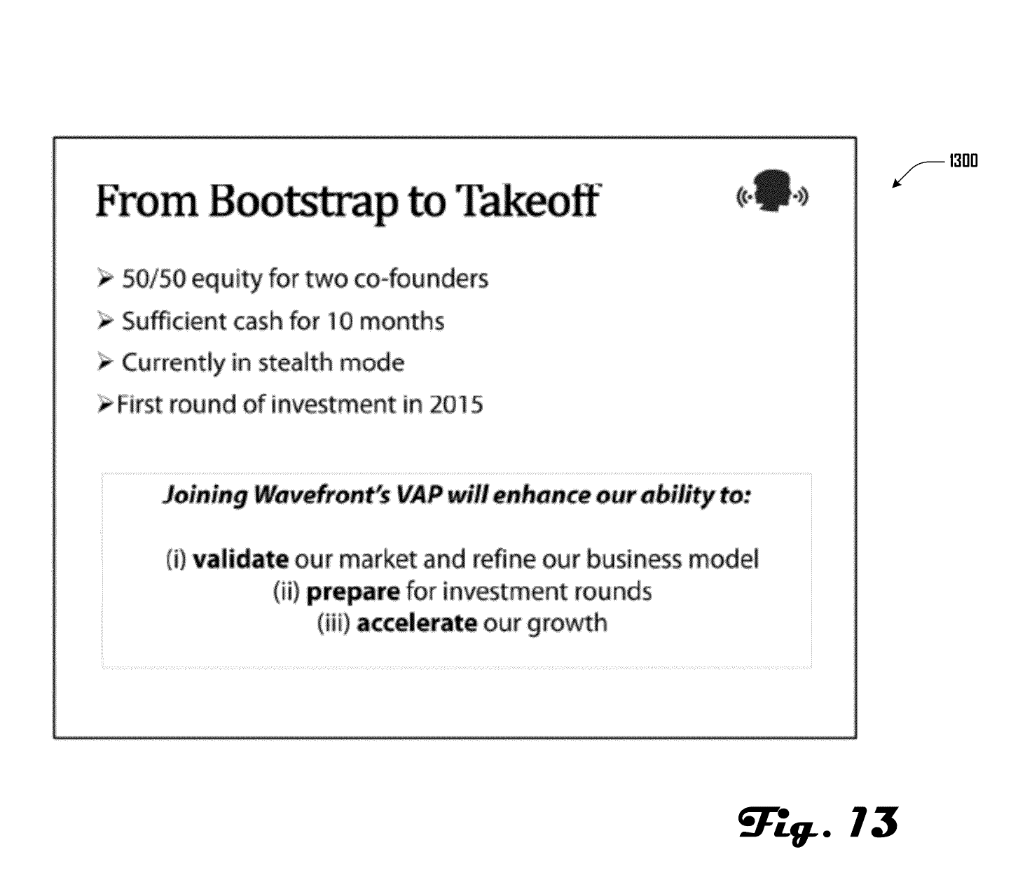

FIG. 13. depicts a development stage.

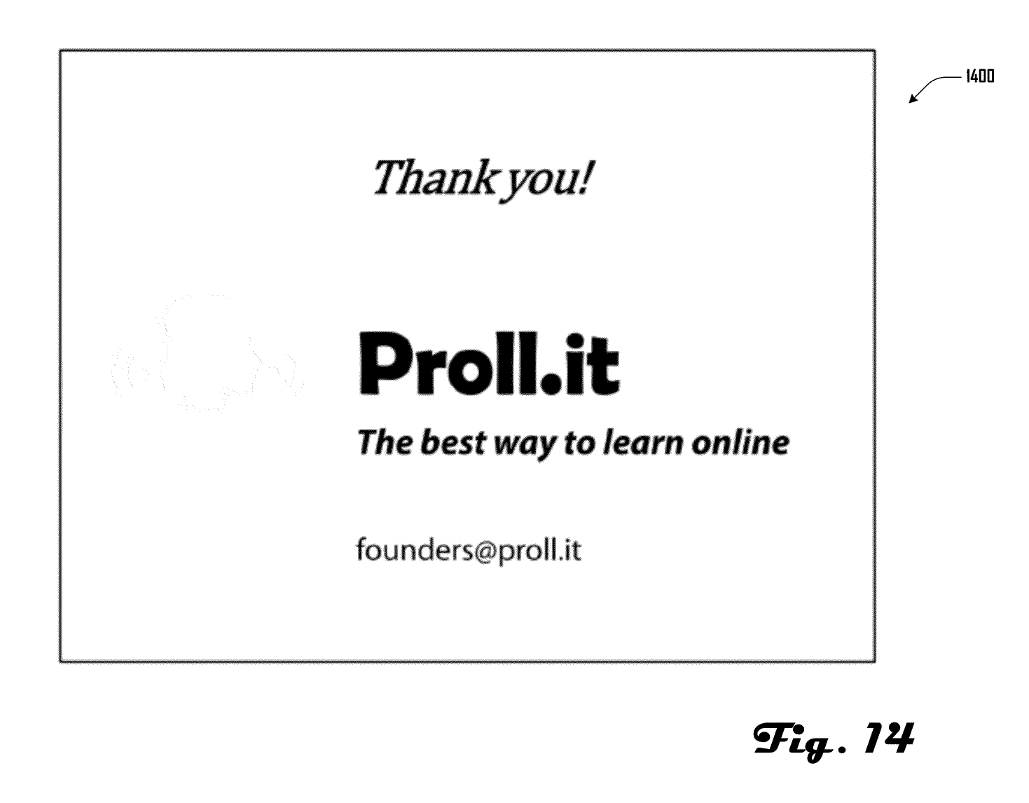

FIG. 14. depicts a conclusion page.

Having thus described the invention, what is claimed is:

1. An interactive online learning system as shown and described above.
